(19) United States
(12) Patent Application Publication
(10) Pub. No.: US 2017/0091690 A1
(43) Pub. Date: Mar. 30, 2017

(54) EFFICIIENTLY ALLOCATING COMPLETED PRODUCT ASSEMBLIES AS INVENTORY IN A CONFIGURE-TO-ORDER ENVIRONMENT

(71) Applicant: INTERNATIONAL BUSINESS MACHINES CORPORATION, ARMONK, NY (US)

(72) Inventors: GYULA HALASI, SZIGETSZENTMIKLOS (HU); TAMAS IMRENYI, BUDAPEST (HU); JASON S. LEE, ORONOCO, MN (US); JUAN F. VARGAS, ROCHESTER, MN (US)

(21) Appl. No.: 14/871,689

(22) Filed: Sep. 30, 2015

(51) Int. Cl. G06Q 10/06; G06Q 30/02; G06Q 10/08

(52) U.S. Cl. CPC G06Q 10/06315; G06Q 10/087; G06Q 30/0202

(57) ABSTRACT

A particular assembly is exploded into a first structure specifying multiple levels each comprising at least one component configured within each of the levels. One or more differences are detected from any level of the first structure of the particular assembly for the demand and to any level of a second structure of one or more selected completed assemblies from among the one or more completed assemblies. An order is allocated to the demand, based on the one or more differences, of at least one of a set, a subset, and a superset of the one or more selected completed assemblies, for efficiently managing manufacturing of configurable products within the configure-to-order environment.

### BACKGROUND

1. Technical Field

The embodiment of the invention relates generally to a data processing system and particularly to efficiently allocating finished product assemblies as inventory in a configure-to-order environment.

2. Description of the Related Art

Each new generation of high end configurable electronic products, including server computers, storage, consumer goods, and networking and switching equipment continue to increase in complexity and relative size and capability. Processing power, memory cache, system memory, and disk capacity continue to rapidly increase, with firmware and software running on those systems increasing in complexity to drive more features. Even former low end′ systems have far exceeded the capacity and capabilities of their former ‘high end’ predecessors.

The increase in complexity has led to an increase in the cycle times to set up, configure, and test products, which is counterproductive to the goal of a linear manufacturing process, which implements an efficient and responsive supply chain process. With the increase in cycle times to set up, configure, and test products, in a linear manufacturing process, if customer orders come late in a measuring period manufacturing will not have time to fulfill the orders and produce satisfied customers. Manufacturing has developed many types of pre-testing processes that can reduce the cycle time for fulfillment of the product to the final customer order by moving the configuration and test cycle time outside of that fulfillment order. Moving the configuration and test cycle time outside of the fulfillment order may work well when products are not very configurable, but breaks down when product variations and order configurability can drive essentially limitless configurations for any particular product.

### BRIEF SUMMARY

In one embodiment, a method is directed, responsive to determining that the demand for a particular assembly for an order load in a dynamic configure-to-order environment requires evaluation of availability of one or more completed assemblies within an inventory, to exploding, by a computer, the particular assembly into a first structure specifying a plurality of levels each comprising at least one component configured within each of the plurality of levels. The method is directed to detecting, by the computer, one or more differences from any level of the first structure of the particular assembly for the demand and to any level of a second structure of one or more selected completed assemblies from among the one or more completed assemblies. The method is directed to allocating, by the computer, an order to the demand, based on the one or more differences, at least one of a set, a subset, and a superset of the one or more selected completed assemblies, for efficiently managing manufacturing of configurable products within the configure-to-order environment.

In another embodiment, a computer system comprises one or more processors, one or more computer-readable memories, one or more computer-readable storage devices, and program instructions, stored on at least one of the one or more storage devices for execution by at least one of the one or more processors via at least one of the one or more memories. The stored program instructions comprise program instructions, responsive to determining that the demand for a particular assembly for an order load in a dynamic configure-to-order environment requires evaluation of availability of one or more completed assemblies within an inventory, to explode the particular assembly into a first structure specifying a plurality of levels each comprising at least one component configured within each of the plurality of levels. The stored program instructions comprise program instructions to detect one or more differences from any level of the first structure of the particular assembly for the demand and to any level of a second structure of one or more selected completed assemblies from among the one or more completed assemblies. The stored program instructions comprise program instructions to allocate an order to the demand, based on the one or more differences, at least one of a set, a subset, and a superset of the one or more selected completed assemblies, for efficiently managing manufacturing of configurable products within the configure-to-order environment.

In another embodiment, a computer program product comprising one or more computer-readable storage devices and program instructions, stored on at least one of the one or more storage devices. The stored program instructions comprise program instructions, responsive to determining that the demand for a particular assembly for an order load in a dynamic configure-to-order environment requires evaluation of availability of one or more completed assemblies within an inventory, to explode the particular assembly into a first structure specifying a plurality of levels each comprising at least one component configured within each of the plurality of levels. The stored program instructions comprise program instructions to detect one or more differences from any level of the first structure of the particular assembly for the demand and to any level of a second structure of one or more selected completed assemblies from among the one or more completed assemblies. The stored program instructions comprise program instructions to allocate an order to the demand, based on the one or more differences, at least one of a set, a subset, and a superset of the one or more selected completed assemblies, for efficiently managing manufacturing of configurable products within the configure-to-order environment.

### BRIEF DESCRIPTION OF THE SEVERAL VIEWS OF THE DRAWINGS

The novel features believed characteristic of one or more embodiments of the invention are set forth in the appended claims. The one or more embodiments of the invention itself however, will best be understood by reference to the following detailed description of an illustrative embodiment when read in conjunction with the accompanying drawings, wherein:

FIG. 1 illustrates one example of block diagram of a free association engine for managing a free allocation of completed, pre-tested assemblies and components in a configure-to-order environment;

FIG. 2 illustrates one example of a block diagram of assembly selections including completed assemblies for fulfilling an order load for a configurable product order load at multiple levels a bill of materials tree;

FIG. 3 illustrates one example of a block diagram of an association table specifying locations of components and specifying component associations at each of multiple levels of different assemblies;

FIG. 4 illustrates one example of a block diagram of a computer system in which one embodiment of the invention may be implemented;

FIG. 5 illustrates one example of a high level logic flowchart of a process and computer program for managing a fully qualified association process within the resource analysis performed by an inventory management system;

FIG. 6 illustrates one example of a high level logic flowchart of a process and computer program for managing a fully qualified association process of a free association engine; and

FIG. 7 illustrates one example of a high level logic flowchart of a process and computer program for managing a free association engine to identify structure of completed assemblies, determine associations between assemblies from any level to any level, and set reconfiguration requirements for associations.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

In addition, in the following description, for purposes of explanation, numerous systems are described. It is important to note, and it will be apparent to one skilled in the art, that the present invention may execute in a variety of systems, including a variety of computer systems and electronic devices operating any number of different types of operating systems.

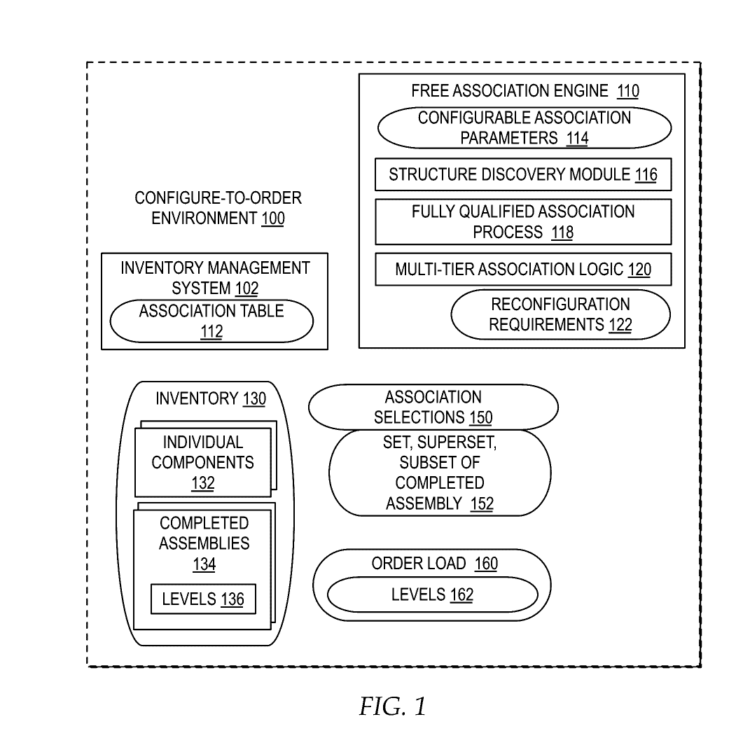

FIG. 1 illustrates a block diagram of one example of a free association engine for managing a free allocation of completed, pre-tested assemblies and components in a configure-to-order environment.

In one example, a configure-to-order environment 100 may represent an environment for managing order fulfillment for configurable electronic products, such as, but not limited to, server computers, storage, consumer goods, and networking and switching equipment. As processor power, memory cache sizes and speeds, system memory sizes and speeds, and disk capacity continue to increase, the firmware and software running on the systems may also increase in complexity to drive more features on the available hardware. Increases in complexity of configurable electronic products may increase cycle times for set up, configuration, and testing of end products. Within a supply chain fulfillment process of configure-to-order environment 100, product variations and order configurability may lead to limitless configurations for any particular configurable product and may require a variable inventory for order fulfillment.

In one example, configurable products are documented with a bill of materials (BOM). The BOM may include a list of items, parts, assemblies and sub-assemblies representing the product design or how the product is manufactured. The BOM may serve as a way to maintain an accurate list of required components. In one example, a BOM may reflect the parent-child relationships of items, parts, assemblies, and sub-assemblies and show a hierarchical structure of assemblies with related parts and components. In one example, the hierarchical structure of assemblies and subassemblies, with related parts and components may be referred to by tier, where a hierarchical structure may include multiple tiers.

As configurability options for configurable electronic products increases, the demand to produce configurable electronic products within shorter time frames may also increase. In one example, for configure-to-order environment 100 to meet order load requirements in a supply chain fulfillment process in a timely manner for highly variable, configurable products, configure-to-order environment 100 may implement an inventory management system 102 for efficiently managing inventory allocation, from among an inventory 130, to an order load, such as order load 160, to meet a completion time requirement for each product within order load 160. In one example, inventory 130 may represent the available inventory from one or more locations, such as, but not limited to, on-site inventory, supplier warehouses, and inventory promised to be delivered by suppliers on a specific day. In addition, inventory 130 may include individual components, such as individual drives, carrier trays, and screws, and may include finished products, such as a finished server rack that includes multiple tested hard disk drive (HDD) assemblies, that are available for reallocation to meet order load requirements. In one example, order load 160 may represent the custom configurations within an order book for a particular product or for multiple products, with each product including structural specifications of the assemblies and configurations of components required for each product. In one example, the structural specifications of the assemblies and configurations of components required for each product within order load 160 may be referred to as levels 162, where levels 162 may specify the types of components required for each level of each assembly included within each product within order load 160, where each product may include one or more tiers of assemblies, each including one or more levels. In one example, order load 160 may further specify each product according to the delivery requirement for each product.

In one example, inventory management system 102 may organize and identify different types and levels of current inventory within inventory 130. In one example, inventory management system 102 may organize inventory according to whether the inventory is an individual component, illustrated as individual components 132, or whether the inventory is a completed assembly, such as a completed assembly within a finished product that is available as inventory, illustrated as completed assemblies 134. In one example, a completed assembly may include, but is not limited to, an assembled hardware disk drive that includes multiple individual components, such as individual drives, carrier trays, and screws. In one example, completed assemblies 134 may refer to completed structures that include one or more levels 136, with one or more components in each level, where the assembly of the components has been completed and tested. In one example, completed assemblies 134 may also refer to a completed product that includes a single or multiple tier assembly, with each assembly including one or more levels.

Within inventory 130 available for allocation to fulfill orders in configure-to-order environment 100, while the inventory may include multiple individual components 132 that can be easily allocated on a 1 to 1 basis to the multiple levels requested in a configurable product, the inventory may also include completed assemblies 134 within one or more finished products, where each assembly may include multiple levels of components, which, which may only be optimized if the multiple levels of structure of inventory is associated on a 1 to N or N to 1 basis for allocation. There is a need for efficiently allocating completed assemblies 134 as inventory in configure-to-order environment 100 by determining and associating inventory, including completed assemblies 134 within finished products, from any level to any level of an order load for efficiently managing manufacturing configurable products. In particular, in one example, for inventory management system 102 to efficiently manage inventory allocation from among inventory 130 that includes multiple levels and types of inventory items, inventory management 102 may need to manage inventory allocation from inventory 130 to order load 160 from any level to any level, including but not limited to, a 1:1 level, a 1:N level and an N:1 level. In one example, inventory management system 102 may specify and maintain an association table 112 that specifies associations of inventory to required parts in an order load from any level to any level, including, but not limited to, 1:1, 1:N and N:1 levels.

In one example, a 1:1 level allocation allows inventory management system 102 to allocate available inventory to manufacturing for a one to one matching component or substitute component. For example, at a 1:1 level, association table 112 may specify that an “assembly part A” in order load 160 may be fulfilled from inventory of a matching “assembly part A” or a substitute “assembly part B” from inventory 130. Within inventory 130, inventory management system 102 may simply identify individual components 132 at an individual component level to allow efficient allocation of individual components 132 from inventory 130 to an individual component required in order load 160. For example, if order load 160 includes a requirement for a selection of individual components “assembly part A”, a 1:1 level allocation allows inventory management system 102 to allocate a matching “assembly part A” or a substitute “assembly part B”, as specified in association table 112.

In one example, while a 1:1 relationship between one component in inventory and one component in order load 106, from any level in individual components 132 to any level in levels 162, is simple to identify, manage, and allocate, in contrast, for completed assemblies 134 within inventory 130, identifying, managing and allocating completed assemblies 134 from any level within levels 136 to any level within levels 162, to enable 1:N and N:1 associations, is more complex. In particular, for inventory management system 102 to identify completed assemblies 134 as both a completed assembly and according to the component parts within the assembly, manage the completed assemblies 134, as a set, superset, or subset of the existing completed assembly within allocation table 112, and determine whether or not to allocate completed assemblies, requires more complex inventory management and more complex decision making for allocations than may be required for identifying, managing and allocating individual components 132. In one example, association selections 150 include selections of inventory from among inventory 130 for meeting order load 160 from among individual components 132 and completed assemblies 134, where association selections 150 may further specify selection from among completed assemblies 134 by specifying a set, superset, or subset of a completed assembly 152.

In one example, for inventory management system 102 to identify, manage, and allocate completed assemblies 134 from any level to any level within order load 106, inventory management system 102 may implement a free association engine 110 for identifying, managing, and allocating completed assemblies 134 to enable inventory management system 102 to determine whether there is an inventory of completed assemblies 134, currently built and available in manufacturing, which can be used as inventory to satisfy order load 106 for other assemblies or components, without needing to perform a complete or partial build of a requested assembly in order load 106. In one example, free association engine 110 removes the constraints of product structure and the “as built” state of completed assemblies and products in manufacturing by creating a multi-level association capability and an unlimited, fully qualified internal structure association process to provide for free allocation of completed, pre-tested assemblies and components to association selections 150 for order load 160 when association selections 150 may span multiple levels of structure and may include one or more material substitutions in order to make the best use of inventory 130, as specified by set, superset, and subset of completed assembly 152. In one example free association engine 110 may be integrated into inventory management system 102 or other existing components of configure-to-order environment 100 to so that all available inventory, from individual components and completed, reusable assemblies within a warehouse to new product inventory, may be best used for an order load until the order load is satisfied.

In one example, free association engine 110 may implement and specify, within association table 112, configurable association parameters 114. In one example, configurable association parameters 114 are configurable to identify associations of inventory 130 from any level, to any level, such as 1:1, 1:N, and N:1 associations in single or multiple product assembly tiers. In one example, by including 1:N and N:1 assembly associations in associations table 112 through configurable association parameters 114, free association engine 110 may handle free association of multiple different assemblies of any level to make one completed new assembly, or conversely, may convert one assembly into multiple assemblies at a different level on demand. In one example, configurable association parameters 114 are also configurable, by free association engine 110, on demand, to enable associations within associations table 112 based on any conversion that may be identified by free association engine 110, and is not limited to pre-defined, manually entered, associations of parts within predefined families.

In one example, free association engine 110 may implement a structure discovery module 116. In one example, structure discovery module 116 may be implemented during one or more process stages within the stages implemented within configure-to-order environment 100, such as during a data extraction process. In one example, structure discovery module 116 may identify all available assemblies and configurations in manufactured products, including previously manufactured products and newly manufactured plant products, for inclusion within completed assemblies 134, explode the actual multiple level structure of each available product to determine the product identifiers, physical locations, and quantities of components included in each level, and store the product identifiers, physical locations, and quantities with exploded multiple level structure in association table 112, with configurable association parameters 114 specified for association from any level to any level. In particular, configurable association parameters are specified to designate an association relationship at a component basis, a level basis, and a completed assembly basis for each completed assembly to replace an associated assembly by adding or removing certain parts or quantities of the associated assembly, including specifying subset and superset relationships between assemblies.

In one example, free association engine 110 may implement a fully qualified association process 118 and may implement multi-tier association logic 120. In one example, fully qualified association process 118 may analyze order load 106 and any other data indicating the demand for each of individual components 132 and for each of completed assemblies 134. In one example, fully qualified association process 118 may utilize association table 112 and multi-tier association logic 120 to identify usage opportunities for completed assemblies 134, for making best use of all of inventory 130. In one example, multi-tier association logic 120 may perform a recursive process to determine the best usages for each of completed assemblies 134 based on both minimum reconfiguration of completed assemblies 134 and maximum output of critical, or time sensitive, orders from order load 160. In one example, fully qualified association process 118 may run prior to a standard inventory allocation process, and include the newly manufactured plant products within completed assemblies 134, to ensure that all pre-tested, pre-configured, or cancelled and available inventory is used before the new plant products within completed assemblies 134 of inventory 130. Multi-tier association logic 120, using association table 112 in a recursive process, may determine any reconfiguration requirements to make one or more reconfigurable assemblies of completed assemblies 134 match the demand identified by fully qualified association process 118, store the reconfiguration requirements as reconfiguration requirements 122, and enable use of one or more reconfigurable assemblies of completed assemblies 134 even when configurations within the reconfigurable assemblies do not exactly match the assembly configuration in order load 106.

In one example, by implementing free association engine 110 to freely associate available inventory, including completed assemblies 134, from any level to any level, free association engine 110 enables pretesting processes with full reconfigurability. In particular, during a manufacturing process within configure-to-order environment 100, the manufacturing process can save time by using completed assemblies 134 selected by free association engine 110, which when used as completed, are pre-tested and do not require additional testing during manufacturing, which may save time during manufacturing. In addition, during the manufacturing process within configure-to-order environment 100, the manufacturing process is not locked into specific configurations of completed assemblies 134 and as directed by free association engine 110, may recombine subsets of assemblies from completed assemblies 134 at will. In addition, by implementing free association engine 110 to freely associate available inventory, including completed assemblies 134, from any level to any level, the manufacturing process may make sue of available completed assemblies from among completed assemblies 134 to fulfill orders from among order load 160.

In one example, by implementing free association engine 110 to freely associate available inventory, including completed assemblies 134, from any level to any level, free association engine 110 enables easy identification during manufacturing of which available assemblies from among completed assemblies 134 to use in which orders, from among orders load 170, with the capability to use the stock location, assembly part serial number, and other relevant data to identify the assembly required from among completed assemblies 134.

In addition, by implementing free association engine 110, configure-to-order environment 100 is enabled to make best use, during the manufacturing process, of available inventory of completed assemblies within tested machines that are not yet shipped, cancelled products, and pre-built stock to maximize output and revenue. By free association engine 110 efficiently and effectively selecting completed assemblies from among completed assemblies 134 to use during manufacturing of configurable products, configure-to-order environment 100 may the reduce the cycle time from manufacturing an order to shipment to meet delivery requirements and maintain customer satisfaction.

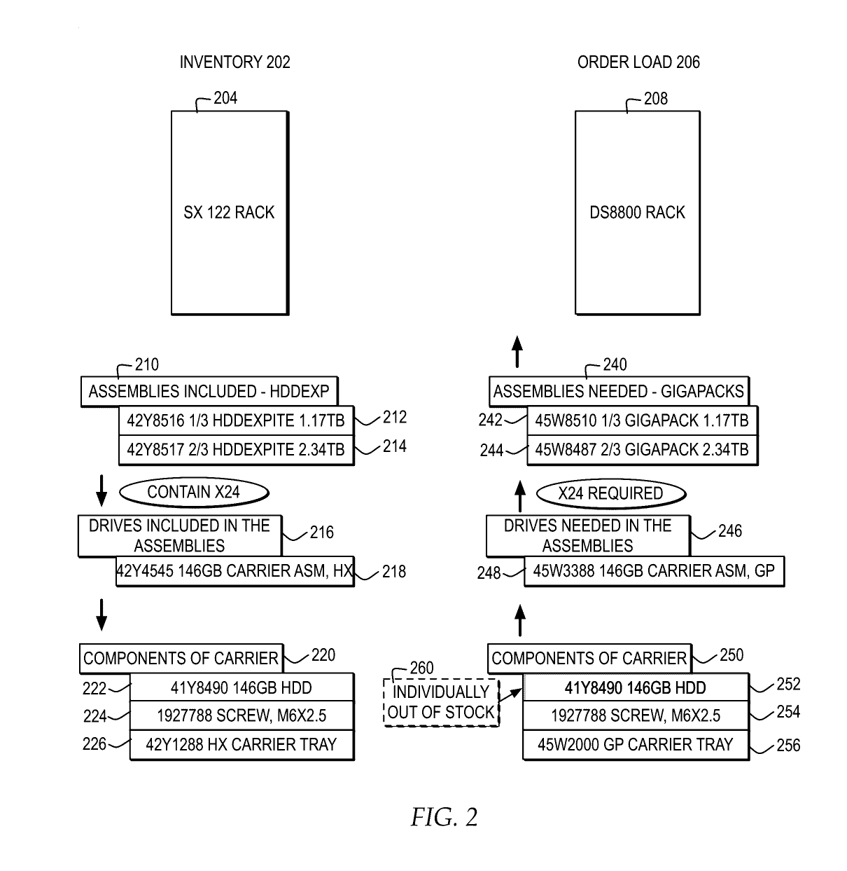

FIG. 2 illustrates a block diagram of one example of assembly selections including completed assemblies for fulfilling an order load for a configurable product order load at multiple levels a bill of materials tree.

In one example, an order load 206 includes a BOM tree specification for a rack 208, specified as a type “DS8800 RACK”. In one example, rack 208 is specified for shipment in two days. In the example, the assemblies needed 240 in a type “DS8800 RACK” are labeled as “GIGAPACKS”, and include a type of GIGAPACK specified as “45W8510 1/3 GIGAPACK 1.17 TB”, illustrated at reference numeral 242, and as “45W8487 2/3 GIGAPACK 2.3 TB”, illustrated at reference numeral 244. In one example, drives needed in the assemblies 246, specifies that 24 times (×24) the number of drives are required for each assembly, where the drive is specified as “45W3388 146 GB CARRIER ASM, GP”, as illustrated at reference numeral 248. In one example, components of each carrier 250 includes a hard disk drive (HDD), specified as a type “41Y8490 146 GB HDD”, illustrated at reference numeral 252, a type “1927788 SCREW, M6×2.5”, illustrated at reference numeral 254, and a carrier tray of a type “45W2000 GP carrier tray”, illustrated at reference numeral 256.

In one example, the HDD component specified as “41Y8490 146 GB HDD”, as an individual component, is out of stock, as illustrated at reference numeral 260. In the example, because the HDD component, as an individual component, is out of stock, the requested GIGAPACKS specified under assemblies need 240 cannot be built within the timeframe.

In one example, within configure-to-order environment 100, because there are not any individual component HDD's available in inventory to associate with the HDD requirement at reference numeral 252, free association engine 110 may run to determine whether there is any inventory available to associate from any level to any level of rack 208 to fulfill order load 206. In one example, if free association engine 110 were not available to determine whether there is any inventory available to associate from any level to any level of rack 208 to fulfill order load 206, configure-to-order environment 100 may be required to order more individual component HDDs and build the carriers and GIGAPACKS from scratch, which may not be possible within the two days remaining until the product is required to be shipped.

When free association engine 110 is implemented within configure-to-order environment 100, however, free association engine 110 may step through the multiple layers of completed assemblies inventory, such stepping through the levels of a rack 204, which is a completed assembly within inventory 202, to identify the components within each level. In one example, each rack 204, specified as a type “SX122 RACK”, may have multiple assemblies included 210, specified as a type “HDDEXP”, and include a type of HDDEXP specified as “42Y8516 1/3 HDDEXPITE 1.17 TB”, illustrated at reference numeral 212, and as “42Y8517 2/3 HDDEXPITE 2.34 TB”, illustrated at reference numeral 214. In the example, free association engine 110 may determine, from association table 112, that assemblies of a type “HDDEXP” are not a match or substitute for assemblies of a type “GIGAPACKS” required for rack 208.

In one example, drives included in the assemblies 216, specifies that 24 times (×24) the number of drives are included for each assembly, where the drive is specified as “42Y4545 146 GB CARRIER ASM, HX”, as illustrated at reference numeral 218. In the example, free association engine 110 may determine, from association table 112, that carriers of a type “42Y4545” are not a match or substitute for assemblies of a type “45W3388” required for rack 208.

In one example, components of each carrier 220 includes a hard disk drive (HDD), specified as a type “41Y8490 146 GB HDD”, illustrated at reference numeral 222, a type “1927788 SCREW, M6×2.5”, illustrated at reference numeral 224, and a carrier tray of a type “42Y1288 HX carrier tray”, illustrated at reference numeral 226. In one example, free association engine 110 may determine, from association table 112, that HDD of a type “41Y8490 146 GB HDD” illustrated at reference numeral 222 match the HDD of a type “41Y8490 146 GB HDD” illustrated at reference numeral 252.

In the example, free association engine 110 determines that each of the assemblies of the type “HDDEXP” within rack 204 include assemblies that include carriers that include HDDs of a type “41Y8490 146 GB HDD”, required for order load 206. In one example, free association engine 110 allocates the HDDs illustrated at reference numeral 222 from the carriers within the assemblies within rack 204 to the carrier illustrated at reference numeral 248 of order load 206 for inclusion in the assemblies illustrated at reference numeral 240 for rack 208. Free association engine 110 may provide instructions for enabling a manufacturing process to identify the HDDs illustrated at reference numeral 222 in the carriers within the assemblies within rack 204 and to enable the reconfiguration of the HDD's from rack 204 to the assemblies needed 240 for rack 208, resulting in an on-time shipment and making the best use of available resources.

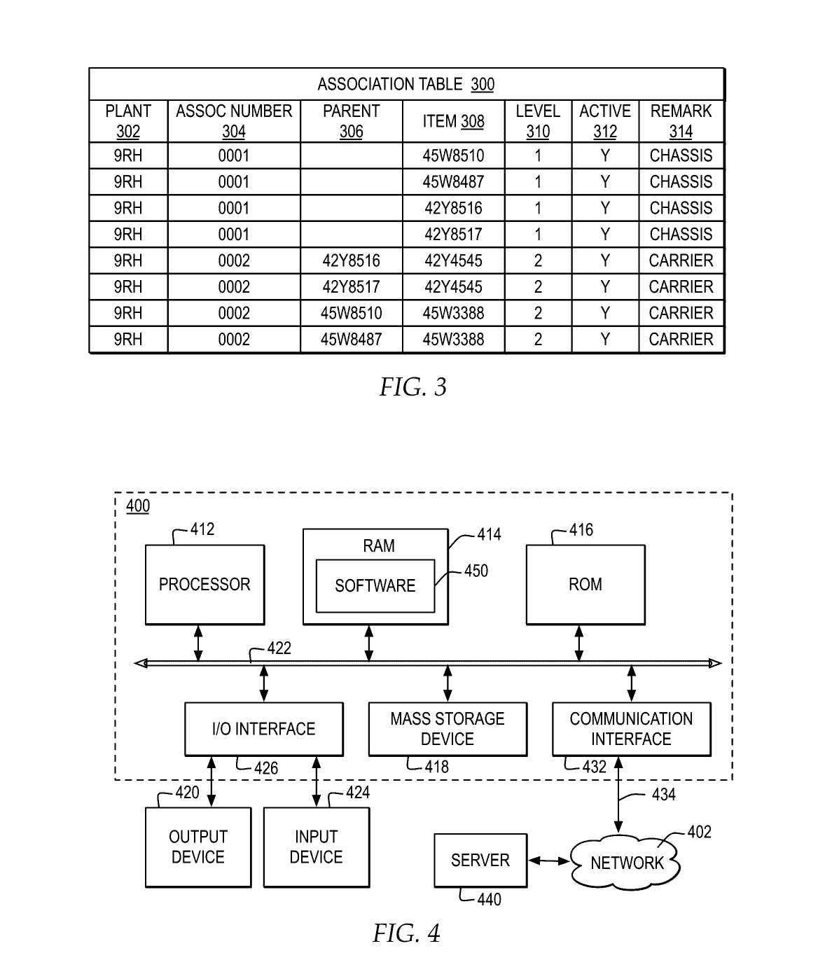

FIG. 3 illustrates a block diagram of one example of an association table specifying locations of components and specifying component associations at each of multiple levels of different assemblies.

In one example, an association table 300 may include a plant column 302, including an identifier of a location of an inventory item illustrated as “9RH” for each of the entries illustrated. In one example, association table 300 may include an association number 304, illustrated as “0001” for the first, second, third, and fourth entries of association table 300 and illustrated as “0002” for fifth, sixth, seventh, and eighth entries of association table 300.

In one example, association table 300 includes an item column 308, where item column 308 identifies component items by part identifier, a level column 310, identifying a level of a part within a completed assembly, an active column 312 identifying whether a part is active in inventory and available for allocation, and a remark column 314, indicating a portion of a completed assembly the component is positioned within. For example, a first entry identifies a part identifier of “45W8510” with a level of “1” and a remark of “chassis”, identifying the assembly at reference numeral 242 in the first level of the requested assembly for rack 208. A second entry identifies a part identifier of “45W8487” with a level of “1” and a remark of “chassis”, identifying the assembly at reference numeral 244 in the first level of the requested assembly for rack 208. A third entry identifies a part identifier of “42Y8516” with a level of “1” and a remark of “chassis”, identifying the assembly at reference numeral 212 in the first level of the completed assembly within rack 204. A fourth entry identifies a part identifier of “42Y8516” with a level of “1” and a remark of “chassis”, identifying the assembly at reference numeral 214 in the first level of the completed assembly within rack 204.

In the example, association table 300 also includes a parent column 306, where entries in the parent column may indicate a part identifier of a part at a higher level that incorporates the item part identifier. In one example, a fifth entry identifies a parent of “42Y8516” with an item of “42Y4545” with a level of “2” and a remark of “carrier”, identifying the carrier at reference numeral 218 in the second level of the completed assembly within rack 204, already assembled into the assembly illustrated at reference numeral 212. In one example, a sixth entry identifies a parent of “42Y8517” with an item of “42Y4545” with a level of “2” and a remark of “carrier”, identifying the carrier at reference numeral 218 in the second level of the completed assembly within rack 204, already assembled into the assembly illustrated at reference numeral 214. In one example, a seventh entry identifies a parent of “45W8510” with an item of “45W3388” with a level of “2” and a remark of “carrier”, identifying the carrier at reference numeral 248 in the second level of the completed assembly within rack 208, that is available for the assembly illustrated at reference numeral 242. In one example, an eighth entry identifies a parent of “45W8487” with an item of “45W3388” with a level of “2” and a remark of “carrier”, identifying the carrier at reference numeral 248 in the second level of the completed assembly within rack 208, that is available for the assembly illustrated at reference numeral 244.

In additional or alternate examples, association table 300 may include additional entries specifying additional or alternate component items within rack 204 and rack 208 including, but not limited to, items at a level “3”, such as the HDDs referred to at reference numeral 222 and 252, the screws referred to at reference numeral 224 and 254, and the carrier trays referred to at reference numerals 226 and 256.

FIG. 4 illustrates a block diagram of one example of a computer system in which one embodiment of the invention may be implemented. The present invention may be performed in a variety of systems and combinations of systems, made up of functional components, such as the functional components described with reference to a computer system 400 and may be communicatively connected to a network, such as network 402.

Computer system 400 includes a bus 422 or other communication device for communicating information within computer system 400, and at least one hardware processing device, such as processor 412, coupled to bus 422 for processing information. Bus 422 preferably includes low-latency and higher latency paths that are connected by bridges and adapters and controlled within computer system 400 by multiple bus controllers. When implemented as a server or node, computer system 400 may include multiple processors designed to improve network servicing power.

Processor 412 may be at least one general-purpose processor that, during normal operation, processes data under the control of software 450, which may include at least one of application software, an operating system, middleware, and other code and computer executable programs accessible from a dynamic storage device such as random access memory (RAM) 414, a static storage device such as Read Only Memory (ROM) 416, a data storage device, such as mass storage device 418, or other data storage medium. Software 450 may include, but is not limited to, code, applications, protocols, interfaces, and processes for controlling one or more systems within a network including, but not limited to, an adapter, a switch, a server, a cluster system, and a grid environment.

Computer system 400 may communicate with a remote computer, such as server 440, or a remote client. In one example, server 440 may be connected to computer system 400 through any type of network, such as network 402, through a communication interface, such as network interface 432, or over a network link that may be connected, for example, to network 402.

In the example, multiple systems within a network environment may be communicatively connected via network 402, which is the medium used to provide communications links between various devices and computer systems communicatively connected. Network 402 may include permanent connections such as wire or fiber optics cables and temporary connections made through telephone connections and wireless transmission connections, for example, and may include routers, switches, gateways and other hardware to enable a communication channel between the systems connected via network 402. Network 402 may represent one or more of packet-switching based networks, telephony based networks, broadcast television networks, local area and wire area networks, public networks, and restricted networks.

Network 402 and the systems communicatively connected to computer 400 via network 402 may implement one or more layers of one or more types of network protocol stacks which may include one or more of a physical layer, a link layer, a network layer, a transport layer, a presentation layer, and an application layer. For example, network 402 may implement one or more of the Transmission Control Protocol/Internet Protocol (TCP/IP) protocol stack or an Open Systems Interconnection (OSI) protocol stack. In addition, for example, network 402 may represent the worldwide collection of networks and gateways that use the TCP/IP suite of protocols to communicate with one another. Network 402 may implement a secure HTTP protocol layer or other security protocol for securing communications between systems.

In the example, network interface 432 includes an adapter 434 for connecting computer system 400 to network 402 through a link and for communicatively connecting computer system 400 to server 440 or other computing systems via network 402. Although not depicted, network interface 432 may include additional software, such as device drivers, additional hardware and other controllers that enable communication. When implemented as a server, computer system 400 may include multiple communication interfaces accessible via multiple peripheral component interconnect (PCI) bus bridges connected to an input/output controller, for example. In this manner, computer system 400 allows connections to multiple clients via multiple separate ports and each port may also support multiple connections to multiple clients.

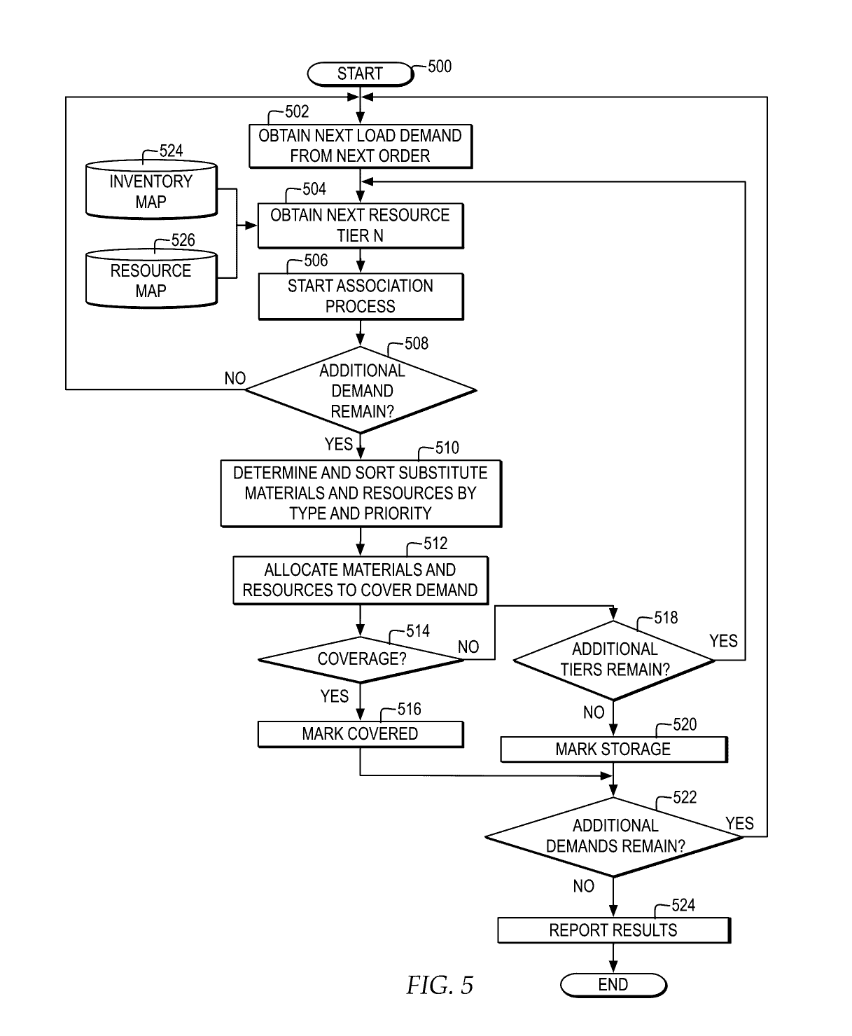

In one embodiment, the operations performed by processor 412 may control the operations of flowchart of FIGS. 5-7 and other operations described herein. Operations performed by processor 412 may be requested by software 450 or other code or the steps of one embodiment of the invention might be performed by specific hardware components that contain hardwired logic for performing the steps, or by any combination of programmed computer components and custom hardware components. In one embodiment, one or more components of computer system 400, or other components, which may be integrated into one or more components of computer system 400, may contain hardwired logic for performing the operations of flowcharts in FIGS. 5-7.

In addition, computer system 400 may include multiple peripheral components that facilitate input and output. These peripheral components are connected to multiple controllers, adapters, and expansion slots, such as input/output (I/O) interface 426, coupled to one of the multiple levels of bus 422. For example, input device 424 may include, for example, a microphone, a video capture device, an image scanning system, a keyboard, a mouse, or other input peripheral device, communicatively enabled on bus 422 via I/O interface 426 controlling inputs. In addition, for example, output device 420 communicatively enabled on bus 422 via I/O interface 426 for controlling outputs may include, for example, one or more graphical display devices, audio speakers, and tactile detectable output interfaces, but may also include other output interfaces. In alternate embodiments of the present invention, additional or alternate input and output peripheral components may be added.

With respect to FIG. 4, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block, diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Those of ordinary skill in the art will appreciate that the hardware depicted in FIG. 4 may vary. Furthermore, those of ordinary skill in the art will appreciate that the depicted example is not meant to imply architectural limitations with respect to the present invention.

FIG. 5 illustrates a high level logic flowchart of a process and computer program for managing a fully qualified association process within the resource analysis performed by an inventory management system.

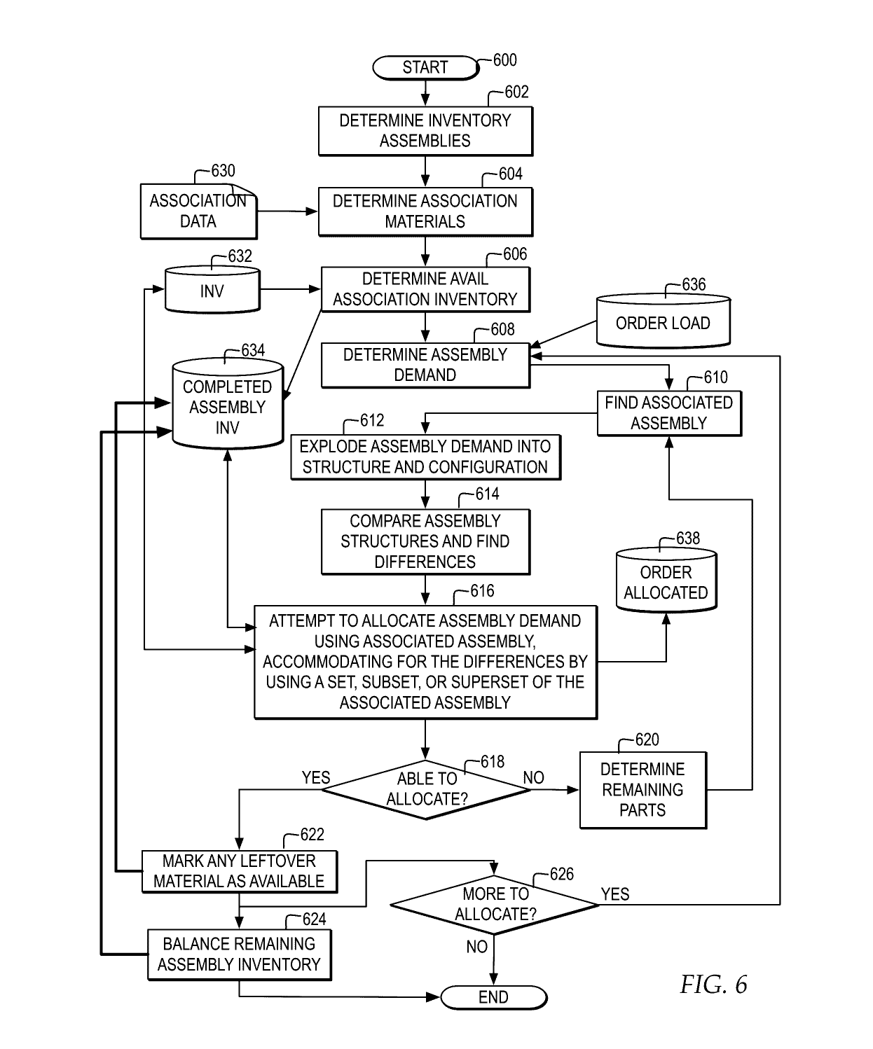

In one example, the process and program starts at block 500 and thereafter proceeds to block 502. Block 502 illustrates obtaining a next load demand from a next order. Net, block 504 illustrates obtaining the next resource tier N required for the next load demand from a next order. In obtaining the next resource tier N, an inventory map 524, mapping inventory 130, and a resource map 526, are accessed. In one example, resource map 526 may contain all the assemblies broken down by components into quantities. In one example, resource map 526 may also indicate the top level parents of the components of each assembly. In one example, resource map 526 may be built in a tree structure to maintain the origin of each component and assembly, to enable balancing of inventory consumption and tracking availability for further allocations. Next, block 506 illustrates starting an association process, which is described with reference to FIG. 6. Thereafter, block 508 illustrates a determination whether additional demand remains for the next load demand from the next order. At block 508, if additional demand does not remain, the process returns to block 502. At block 508, if additional demand remains, the process passes to block 510.

Block 510 illustrates determining and sorting substitute materials and resources by type and priority. Next, block 512 illustrates allocating materials and resources to cover the demand. Thereafter, block 514 illustrates a determination whether there is coverage for the demand in the allocated materials and resources. At block 514, if there is coverage for the demand in the allocated materials and resources, the process passes to block 516. Block 516 illustrates marking the demand as covered, and the process passes to block 522. Block 522 illustrates a determination whether additional order demands remain. At block 522, if additional order demands remain, then the process returns to block 502. At block 522, if no additional order demands remain, then the process passes to block 524. Block 524 illustrates reporting results, and the process ends.

Returning to block 514, if there is not coverage for the demand in the allocated materials and resources, the process passes to block 518. Block 518 illustrates a determination whether additional tiers remain in the demand. At block 518, if additional tiers remain in the demand, then the process returns to block 504. Returning to block 518, if additional tiers do not remain in the demand, then the process passes to block 520. Block 520 illustrates marking the allocated materials in storage, and the process passes to block 522.

FIG. 6 illustrates a high level logic flowchart of a process and computer program for managing a fully qualified association process of a free association engine.

In one example, the process and program start at block 600 and thereafter proceed to block 602. In one example, block 600 is triggered at block 506 of FIG. 5, for performing an association process on a next load demand from a next order, including a resource tier N, to determine whether there are potential assemblies from finished products in manufacturing that can be used as a source of the material for the allocation of inventory to the next load demand. In one example, block 602 illustrates determining a selection of parts in inventory classified as inventory assemblies, within inv 632, as distinguished from other parts in inventory classified as regular purchase parts. Next, block 604 illustrates determining association materials for the inventory assemblies, based on association data 630 from an association table. Thereafter, block 606 illustrates determining the available association inventory matching the association materials, based on an inventory 632, including a completed assembly inventory 634, including finished products in manufacturing and other completed products that are available for reuse.

Next, block 608 illustrates determining the current assembly demand for a load order, based on order load 636. Thereafter, block 610 illustrates finding one or more associated assemblies from completed assembly inventory 634 that are available to meet the current assembly demand from among the inventory assemblies matching the association materials. In one example, finding one or more associated assemblies that are available to meet the current assembly demand may include looking into the setup and configuration information in association data 630 from the association table to determine what potential alternate assembly may be used to satisfy the order demand of a particular assembly part, including tracing through a list in the association table to exhaust the list and satisfy the demand. Next, block 612 illustrates exploding the assembly demand into the structure and configuration elements for the assembly demand, including levels of the assembly demand and components in each level. Next, block 614 illustrates comparing the assembly structure of the assembly demand with the structure of the associated assembly identified from the available inventory and determining any differences between the assembly demand and the associated assembly. The difference may include, but are not limited to, determining parts and quantities of the associated assembly that are missing or need to be added or determining whether the associated assembly requires part removal to match the assembly demand. Thereafter, block 616 illustrates attempting to allocate the associated assembly from inventory 632 or completed assembly inventory 634 to an order allocated database 638 for the assembly demand, accommodating for the differences by using a set, subset, or superset of the associated assembly. Next, block 618 illustrates a determination whether the process was able to allocate the associated assembly to the assembly demand. In one example, allocating the associated assembly to the assembly demand may require configuration of the associated assembly in some way, if the associated assembly is available as a subset or superset, which allows for reuse of the associated assembly with modifications, rather than starting from scratch to build a new assembly. At block 618, if the process was not able to allocate to the assembly demand, then the process passes to block 620. Block 620 illustrates determining the remaining parts that are not yet allocated, and the process passes to block 610.

Returning to block 618, at block 618, if the process is able to allocate to the assembly demand, then the process passes to block 622. Block 622 illustrates marking any leftover material, if not required in a reconfigured associated assembly, as available in completed assembly inventory 634, and the process passes to block 624 and block 626. Block 624 illustrates balancing the remaining assembly inventory within completed assembly inventory 634, and the process ends. Block 626 illustrates a determination whether there is more to allocate. At block 626, if there is more to allocate, then the process returns to block 608, and the process is executed for all assemblies found during the inventory allocation until all order load processing is exhausted. At block 626, if there is not more to allocate, then the process ends.

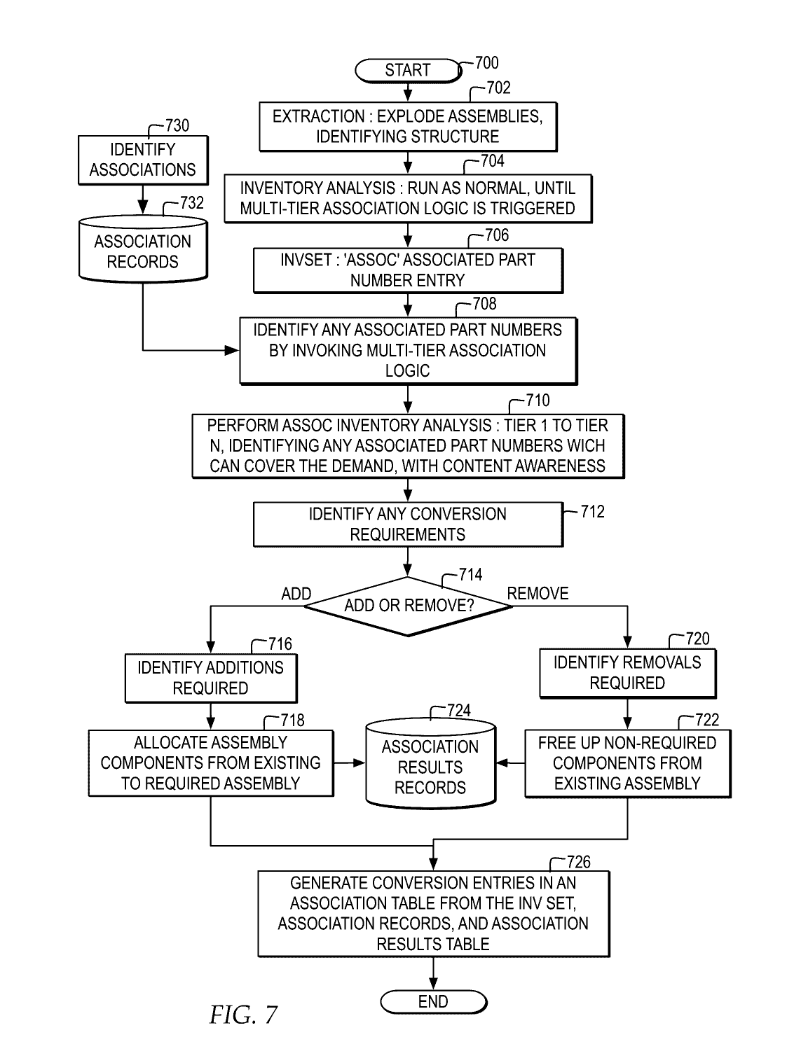

FIG. 7 illustrates a high level logic flowchart of a process and computer program for managing a free association engine to identify structure of completed assemblies, determine associations between assemblies from any level to any level, and set reconfiguration requirements for associations.

In one example, a process and program start at block 700 and thereafter proceed to block 702. Block 702 illustrates an extraction, including exploding each assembly and identifying and maintaining a structure of each assembly. Next, block 704 illustrates an inventory analysis, of running as normal, until multi-tier association logic is triggered. Thereafter, block 706 illustrates managing an inventory set table (INVSET) for setting an association (“ASSOC”) associated part number entry in the INVSET table, for holding information for the association logic. For example, an INVSET table may include a tier identifier, a parameter for telling a process when to execute, and a sequence number, where parameters may include “SUB” for a substitution analysis process, “ASSOC” for an association analysis process, and “ASSEM” for an assembly analysis process. Next, block 708 illustrates identifying any associated part numbers by invoking multi-tier association logic. Invoking multi-tier association logic may include accessing association records 732, which include records determined by identifying associations as illustrated at block 730. In one example, association records 732 may specify an item identifier, which may also indicate a quantity an assembly may include. In one example, two assemblies may be identical in terms of part numbers, but the quantities of parts in each assembly may differ. For example, a first disk chassis assembly may include 24 disks of a particular part number and a second disk chassis assembly may include 12 disks of the same part number. In one example, to quantities may be indicated in terms such as “full”, “half”, or “third” In addition, the item identifier in association records 732 may identify an association “ASSOC” code, such as “GIGAPACK A”, an “ASSOC” item number, such as “2”, and an “ASSOC” prio. In one example, the “ASSOC” item number may represent an indicator of what the “ASSOC” code “GIGAPACK A” can be associated with. For example, a full “GIGAPACK A” with an “ASSOC” item number of “2” may be associated with a third “GIGAPACK A” with an “ASSOC” item number of “2”. The “ASSOC” prio may indicate what priority the association will process into to satisfy the allocation “ALLOC” analysis. In one example, some assemblies may be assigned a higher priority than other assemblies to indicate which assemblies should be assessed first for association.

Next, block 710 illustrates performing “ASSOC” inventory analysis, from tier 1 to tier N, by identifying any associated part numbers that can cover a demand, with content awareness. Next, block 712 illustrates identifying any conversion requirements. Thereafter, block 714 illustrates a determination whether any conversion requirements require adding or removing. If any conversation requirements require adding, then process passes to block 716. Block 716 illustrates identifying the additions required. Next, block 718 illustrates allocating assembly components from existing to required assemblies and updating association results records 724 with the allocations, and the process passes to block 726. In one example, association results records 724 may include records that identify an item, identify a “from assembly (ASM)” identifier identify a “from serial number (SN)” identifier, identify a “to ASM” identifier, and identify a “to SN” identifier. In addition, each record in association results records 724 may identify, for each “from ASM”/“from SN” pairing and for each “to ASM”/“to SN” pairing, a warehouse of source of the assembly (WSHSE), an area, a location identifier, and a bin identifier, to specify the location of parts required for additions or removals to associations.

Returning to block 714, if any conversion requirements require removing, then the process passes to block 720. Block 720 illustrates identifying the removals required. Next, block 722 illustrates freeing up non-required components from an existing assembly and updating association results record 724 with the allocations, and the process passes to block 726.

Block 726 illustrates generating conversion entries in an association table from the INV set, association records, and association results table, and the process ends.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification specify the presence of stated features, integers, steps, operations, elements, and/or components, but not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the one or more embodiments of the invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the invention has been particularly shown and described with reference to one or more embodiments, it will be understood by those skilled in the art that various changes in form and detail may be made therein without departing from the spirit and scope of the invention.

What is claimed is:

1. A method, comprising:
responsive to determining that the demand for a particular assembly for an order load in a dynamic configure-to-order environment requires evaluation of availability of one or more completed assemblies within an inventory, exploding, by a computer, the particular assembly into a first structure specifying a plurality of levels each comprising at least one component configured within each of the plurality of levels;
detecting, by the computer, one or more differences from any level of the first structure of the particular assembly for the demand and to any level of a second structure of one or more selected completed assemblies from among the one or more completed assemblies; and
allocating, by the computer, an order to the demand, based on the one or more differences, at least one of a set, a subset, and a superset of the one or more selected completed assemblies, for efficiently managing manufacturing of configurable products within the configure-to-order environment.

2. The method according to claim 1, wherein detecting, by the computer, one or more differences from any level of the first structure of the particular assembly for the demand and to any level of a second structure of one or more selected completed assemblies from among the one or more completed assemblies further comprises:
identifying one or more first part numbers within any level of the first structure that are associated within an association table with one or more second part numbers within any level of the second structure;
identifying the one or more differences from any level of the first structure to any level of the second structure based on one or more additional first part numbers within any level of the first structure that do not match one or more additional second part numbers within any level of the second structure; and
specifying an association table with an association relationship between the particular assembly and the one or more selected completed assemblies specifying the one or more differences to designate whether the association requires one of the superset and the subset.

3. The method according to claim 1, wherein detecting, by the computer, one or more differences from any level of the first structure of the particular assembly for the demand and to any level of a second structure of one or more selected completed assemblies from among the one or more completed assemblies further comprises:
detecting, by the computer, one or more differences requiring additional components in a particular completed assembly from among the one or more completed assemblies; and
associating, by the computer, at least one level of the particular completed assembly with one or more levels of one or more additional completed assemblies from among the one or more completed assemblies to make one new assembly for allocation to the order as the superset of the one or more selected completed assemblies.

4. The method according to claim 1, wherein detecting, by the computer, one or more differences from any level of the first structure of the particular assembly for the demand and to any level of a second structure of one or more selected completed assemblies from among the one or more completed assemblies further comprises:
detecting, by the computer, one or more differences requiring fewer components in a particular completed assembly from among the one or more completed assemblies; and
converting, by the computer, the particular completed assembly into a plurality of new separate assemblies at different levels, a particular new separate assembly from among the plurality of new separate assemblies allocated to the order as the subset of the one or more selected completed assemblies.

5. The method according to claim 4, further comprising:
marking, by the computer, the additional new separate assemblies other than the particular new separate assembly as available in inventory for allocation.

6. The method according to claim 1, further comprising:
detecting, by the computer, a completion of a finished product comprising one or more completed assemblies that are pre-tested and are currently built in a manufacturing area; and
adding the finished product comprising the one or more completed assemblies to the one or more completed assemblies in the inventory.

7. The method according to claim 1, further comprising:
obtaining the demand for the order load comprising a plurality of demands;
starting an association process for the demand to evaluate the availability of one or more individual components and of the one or more completed assemblies within the inventory;
responsive to completing the association process for the demand, obtaining a next demand for the order load, from among the plurality of demands;
starting the association process for the next demand;
responsive to completing the association process for each of the plurality of demands, determining and storing substitute materials and resources specified in the one or more selected completed assemblies; and
allocating the one or more substitute materials and resources to cover the plurality of demands within the order load.

8. A computer system comprising one or more processors, one or more computer-readable memories, one or more computer-readable storage devices, and program instructions, stored on at least one of the one or more storage devices for execution by at least one of the one or more processors via at least one of the one or more memories, the stored program instructions comprising:
program instructions, responsive to determining that the demand for a particular assembly for an order load in a dynamic configure-to-order environment requires evaluation of availability of one or more completed assemblies within an inventory, to explode the particular assembly into a first structure specifying a plurality of levels each comprising at least one component configured within each of the plurality of levels;
program instructions to detect one or more differences from any level of the first structure of the particular assembly for the demand and to any level of a second structure of one or more selected completed assemblies from among the one or more completed assemblies; and
program instructions to allocate an order to the demand, based on the one or more differences, at least one of a set, a subset, and a superset of the one or more selected completed assemblies, for efficiently managing manufacturing of configurable products within the configure-to-order environment.

9. The computer system according to claim 8, the stored program instructions further comprising:
program instructions to identify one or more first part numbers within any level of the first structure that are associated within an association table with one or more second part numbers within any level of the second structure;
program instructions to identify the one or more differences from any level of the first structure to any level of the second structure based on one or more additional first part numbers within any level of the first structure that do not match one or more additional second part numbers within any level of the second structure; and
program instructions to specify an association table with an association relationship between the particular assembly and the one or more selected completed assemblies specifying the one or more differences to designate whether the association requires one of the superset and the subset.

10. The computer system according to claim 8, the stored program instructions further comprising:
program instructions to detect one or more differences requiring additional components in a particular completed assembly from among the one or more completed assemblies; and
program instructions to associate at least one level of the particular completed assembly with one or more levels of one or more additional completed assemblies from among the one or more completed assemblies to make one new assembly for allocation to the order as the superset of the one or more selected completed assemblies.

11. The computer system according to claim 8, the stored program instructions further comprising:
program instructions to detect one or more differences requiring fewer components in a particular completed assembly from among the one or more completed assemblies; and
program instructions to convert the particular completed assembly into a plurality of new separate assemblies at different levels, a particular new separate assembly from among the plurality of new separate assemblies allocated to the order as the subset of the one or more selected completed assemblies.

12. The computer system according to claim 11, the stored program instructions further comprising:
program instructions to mark the additional new separate assemblies other than the particular new separate assembly as available in inventory for allocation.

13. The computer system according to claim 8, the stored program instructions further comprising:
program instructions to detect a completion of a finished product comprising one or more completed assemblies that are pre-tested and are currently built in a manufacturing area; and
program instructions to add the finished product comprising the one or more completed assemblies to the one or more completed assemblies in the inventory.

14. The computer system according to claim 8, the stored program instructions further comprising:
program instructions to obtain the demand for the order load comprising a plurality of demands;
program instructions to start an association process for the demand to evaluate the availability of one or more individual components and of the one or more completed assemblies within the inventory;
program instructions, responsive to completing the association process for the demand, to obtain a next demand for the order load, from among the plurality of demands;
program instructions to start the association process for the next demand;
program instructions, responsive to completing the association process for each of the plurality of demands, to determine and store substitute materials and resources specified in the one or more selected completed assemblies; and
program instructions to allocate the one or more substitute materials and resources to cover the plurality of demands within the order load.

15. A computer program product comprising one or more computer-readable storage devices and program instructions, stored on at least one of the one or more storage devices, the stored program instructions comprising:
program instructions, responsive to determining that the demand for a particular assembly for an order load in a dynamic configure-to-order environment requires evaluation of availability of one or more completed assemblies within an inventory, to explode the particular assembly into a first structure specifying a plurality of levels each comprising at least one component configured within each of the plurality of levels;
program instructions to detect one or more differences from any level of the first structure of the particular assembly for the demand and to any level of a second structure of one or more selected completed assemblies from among the one or more completed assemblies; and
program instructions to allocate an order to the demand, based on the one or more differences, at least one of a set, a subset, and a superset of the one or more selected completed assemblies, for efficiently managing manufacturing of configurable products within the configure-to-order environment.

16. The computer program product according to claim 15, the stored program instructions further comprising:
program instructions to identify one or more first part numbers within any level of the first structure that are associated within an association table with one or more second part numbers within any level of the second structure;
program instructions to identify the one or more differences from any level of the first structure to any level of the second structure based on one or more additional first part numbers within any level of the first structure that do not match one or more additional second part numbers within any level of the second structure; and
program instructions to specify an association table with an association relationship between the particular assembly and the one or more selected completed assemblies specifying the one or more differences to designate whether the association requires one of the superset and the subset.

17. The computer program product according to claim 15, the stored program instructions further comprising:
program instructions to detect one or more differences requiring additional components in a particular completed assembly from among the one or more completed assemblies; and
program instructions to associate at least one level of the particular completed assembly with one or more levels of one or more additional completed assemblies from among the one or more completed assemblies to make one new assembly for allocation to the order as the superset of the one or more selected completed assemblies.

18. The computer program product according to claim 15, the stored program instructions further comprising:
program instructions to detect one or more differences requiring fewer components in a particular completed assembly from among the one or more completed assemblies; and
program instructions to convert the particular completed assembly into a plurality of new separate assemblies at different levels, a particular new separate assembly from among the plurality of new separate assemblies allocated to the order as the subset of the one or more selected completed assemblies.

19. The computer program product according to claim 18, the stored program instructions further comprising:
program instructions to mark the additional new separate assemblies other than the particular new separate assembly as available in inventory for allocation.

20. The computer program product according to claim 15, the stored program instructions further comprising:
program instructions to detect a completion of a finished product comprising one or more completed assemblies that are pre-tested and are currently built in a manufacturing area; and
program instructions to add the finished product comprising the one or more completed assemblies to the one or more completed assemblies in the inventory.
